(19) United States
(12) Patent Application Publication
(10) Pub. No.: US 2026/0135210 A1
(43) Pub. Date: May 14, 2026

(54) METHOD OF MANUFACTURING ELECTRICITY STORAGE DEVICE

(71) Applicant: Prime Planet Energy & Solutions, Inc., Tokyo (JP)

(72) Inventor: Kazuki TAMURA, Takasago-shi (JP)

(21) Appl. No.: 19/380,963

(22) Filed: Nov. 6, 2025

(30) Foreign Application Priority Data
Nov. 13, 2024 (JP) 2024-198013

(51) Int. Cl. H01M 50/169; B23K 26/24; H01M 50/183

(52) U.S. Cl. CPC H01M 50/169; B23K 26/24; H01M 50/183

(57) ABSTRACT

A method of manufacturing an electricity storage device includes a first preparing step of preparing a case body including an open end, a second preparing step of preparing a sealing plate for sealing the open end of the case body, an assembling step of attaching the sealing plate to the open end of the case body, and a welding step of welding the case body and the sealing plate by applying a laser beam along a boundary between the case body and the sealing plate. The sealing plate prepared in the second preparing step includes a recessed portion recessed downwardly in a circumferential end portion of an upper surface of the sealing plate. In the welding step, a laser beam is applied to the recessed portion of the sealing plate to weld the case body and the sealing plate.

### CROSS REFERENCE TO RELATED APPLICATIONS

The present application claims priority from Japanese Patent Application No. 2024-198013 filed on Nov. 13, 2024, which is incorporated by reference herein in its entirety.

### BACKGROUND

The present invention relates to a method of manufacturing an electricity storage device.

JP 2018-202478 A, for example, discloses a laser sealing device equipped with means for splitting a laser beam into two beams and means for moving the split two laser beams in parallel along the joint interface between two members. This laser sealing device is configured to cause the split two laser beams to be arranged symmetrically at positions equally distant from the joint interface so that the split two laser beams do not enter the joint interface.

It is stated that high quality welding can be achieved by using this laser sealing device when welding two members. It is stated that using the above-described laser sealing device can prevent the generation of spatter when manufacturing a lithium battery equipped with a container having an opening and a lid that is attached to the opening and is welded to the container.

### SUMMARY

The present inventor intends to ensure a stable weld depth and prevent laser penetration when welding together a case body and a sealing plate of an electricity storage device.

According to the present disclosure, a method of manufacturing an electricity storage device includes a first preparing step, a second preparing step, an assembling step, and a welding step. The first preparing step involves preparing a case body including an open end. The second preparing step involves preparing a sealing plate for sealing the open end of the case body. The assembling step involves attaching the sealing plate to the open end of the case body. The welding step involves welding the case body and the sealing plate by applying a laser beam along a boundary between the case body and the sealing plate. The sealing plate prepared in the second preparing step includes a recessed portion recessed downwardly in a circumferential end portion of an upper surface of the sealing plate. In the welding step, the laser beam is applied to the recessed portion of the sealing plate to weld the case body and the sealing plate.

According to the method of manufacturing an electricity storage device disclosed herein, it is possible to ensure a stable weld depth because it is possible to form a melted weld mark in the recessed portion recessed downwardly in the circumferential end portion of the sealing plate.

### BRIEF DESCRIPTION OF THE DRAWINGS

FIG. 1 is a perspective view schematically illustrating an electricity storage device according to one embodiment.

FIG. 2 is an exploded perspective view illustrating the electricity storage device according to the embodiment.

FIG. 3 is a flowchart illustrating one example of a method of manufacturing an electricity storage device.

FIG. 4 is a cross-sectional view illustrating a fracture surface of a sealing plate prepared in a preparing step.

FIG. 5 is a graph showing the correlation between the weld depth and the fracture surface spatial area in a fracture surface.

FIG. 6 is a plan view illustrating a sealing plate prepared in a second preparing step.

FIG. 7 is a cross-sectional view illustrating the sealing plate prepared in the second preparing step.

FIG. 8 is a cross-sectional view illustrating a sealing plate prepared in a second preparing step in a modified example.

FIG. 9 is a cross-sectional view illustrating a state in which a case body and a sealing plate are welded.

FIG. 10 is a graph showing the correlation between the depth of a recessed portion and the weld depth.

FIG. 11 is a graph showing the correlation between the width of a recessed portion and the weld depth.

### DETAILED DESCRIPTION

Hereinbelow, embodiments of the technology according to the present disclosure will be described with reference to the drawings. It should be noted, however, that the embodiments disclosed herein are, of course, not intended to limit the invention. The drawings are schematic illustrations, and do not necessarily reflect any actual product. The features and components that exhibit the same effects are designated by the same reference symbols as appropriate, and the description thereof will not be repeated as appropriate.

In the present description, the term “electricity storage device” refers to a device that is capable of charging and discharging. The electricity storage device may include a variety of batteries generally referred to as lithium-ion batteries and lithium secondary batteries, as well as batteries such as lithium polymer batteries and nickel-metal hydride batteries. The secondary battery refers to a battery that is capable of charging and discharging repeatedly by means of migration of charge carriers between positive and negative electrodes. The electricity storage device may use either an electrolyte solution or a solid electrolyte. For example, the secondary battery may be a secondary battery that uses what is called a liquid-type electrolyte solution, or may be what is called an all-solid-state battery that uses a solid electrolyte. The electricity storage device may also include capacitors, such as electric double layer capacitors and lithium-ion capacitors.

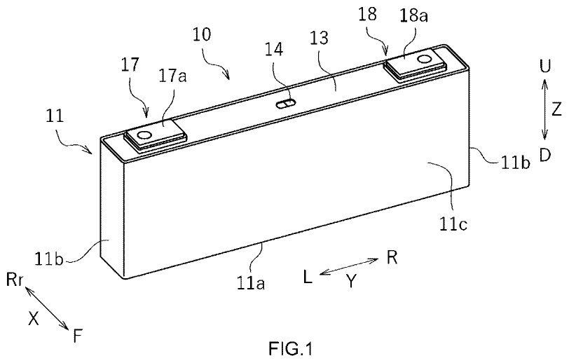

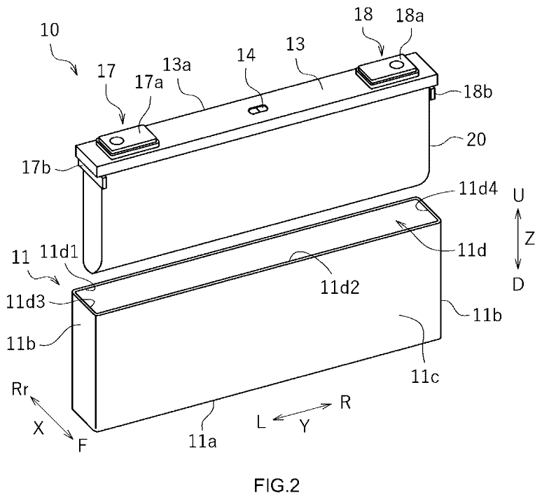

FIG. 1 is a perspective view schematically illustrating an electricity storage device 10. FIG. 2 is an exploded perspective view illustrating the electricity storage device 10. In the present embodiment, the electricity storage device 10 is what is called a lithium-ion secondary battery. In the present embodiment, reference characters F, Rr, L, R, U and D in the drawings represent front, rear, left, right, up, and down, respectively, with respect to the electricity storage device 10. In the drawings, reference characters X, Y, and Z indicate the thickness axis, the width axis, and the height axis of the electricity storage device 10, respectively. Herein, the thickness axis X extends in a front-rear direction. The width axis Y extends in a direction orthogonal to the thickness axis X. The width axis Y extends in a left-right direction. The height axis Z extends in a direction orthogonal to the thickness axis X and the width axis Y. The height axis Z extends in an up-down direction. These directional terms are, however, merely provided for purposes in illustration and are not intended to limit the arrangements and embodiments of the electricity storage device 10 disclosed herein in any way.

As illustrated in FIG. 1, the electricity storage device 10 includes a case body 11, a sealing plate 13, and an electrode body 20 (see FIG. 2). As illustrated in FIG. 2, the case body 11 is a prismatic case including an open end 11d. The open end 11d is formed at the top of the case body 11. The case body 11 is formed in a substantially rectangular parallelepiped shape. The shape of the open end 11d is a rectangular shape. However, the shape of the open end 11d is not limited to any particular shape.

In the present embodiment, the case body 11 includes shorter sides extending along the thickness axis X and longer sides extending along the width axis Y, as viewed in plan. Herein, as illustrated in FIG. 2, the case body 11 includes a bottom surface 11a, a pair of narrower surfaces 11b, and a pair of wider surfaces 11c. The bottom surface 11a forms the bottom of the case body 11 and opposes the open end 11d. The bottom surface 11a is formed in a rectangular shape having shorter sides and longer sides. The pair of narrower surfaces 11b face each other across the width axis Y. The pair of narrower surfaces 11b extend upward from both ends of the width axis Y of the bottom surface 11a (in other words, from the shorter sides of the bottom surface 11a). The pair of wider surfaces 11c face each other across the thickness axis X. The pair of wider surfaces 11c extend upward from both ends of the thickness axis X of the bottom surface 11a (in other words, from the longer sides of the bottom surface 11a). The pair of wider surfaces 11c and the pair of narrower surfaces 11b are continuous. From the viewpoints of reducing weight and providing sufficient rigidity, the case body 11 is formed of aluminum or an aluminum alloy composed mainly of aluminum.

As illustrated in FIG. 2, the open end 11d is surrounded by a rear edge 11d1, a front edge 11d2, a left edge 11d3, and a right edge 11d4. The rear edge 11d1, the front edge 11d2, the left edge 11d3 and the right edge 11d4 form an upper end portion of the case body 11. The rear edge 11d1 and the front edge 11d2 extend along the width axis Y. The rear edge 11d1 is positioned rearward relative to the front edge 11d2. The left edge 11d3 and the right edge 11d4 extend along the thickness axis X. The left edge 11d3 is positioned leftward relative to the right edge 11d4. The left edge 11d3 is connected to the left end of the rear edge 11d1 and the left end of the front edge 11d2. The right edge 11d4 is connected to the right end of the rear edge 11d1 and the right end of the front edge 11d2. In the following description, the rear edge 11d1, the front edge 11d2, the left edge 11d3 and the right edge 11d4 may be collectively referred to as an edge of the open end 11d.

The sealing plate 13 is a member that closes the open end 11d of the case body 11. The sealing plate 13 is attached to the open end 11d along the edge of the open end 11d of the case body 11. The sealing plate 13 has a shape that corresponds to the shape of the open end 11d. Herein, the sealing plate 13 is a flat plate formed in a rectangular shape in plan view. Herein, the sealing plate 13 includes a circumferential end portion 13a. The circumferential end portion 13a forms the front end, the rear end, the left end, and the right end of the sealing plate 13. The circumferential end portion 13a is provided along the circumference of the sealing plate 13 circumferentially around its entire circumference. Although the details will be described later, the open end 11d is sealed by laser welding the circumferential end portion 13a of the sealing plate 13 along the edge of the open end 11d. The sealing plate 13 may be formed of the same material as the case body 11. Herein, the sealing plate 13 may be formed of, for example, aluminum or an aluminum alloy composed mainly of aluminum.

In the present embodiment, as illustrated in FIG. 2, the sealing plate 13 includes a gas vent valve 14 for expelling the gas inside the case body 11. The gas vent valve 14 is provided at a middle portion of the width axis Y of the sealing plate 13. The gas vent valve 14 is, for example, a thinned portion that is designed to rupture when the pressure inside the case body 11 rises higher than or equal to a predetermined value. The gas vent valve 14 ruptures when the pressure inside the case body 11 reaches higher than or equal to a predetermined value, whereby the gas inside the case body 11 is expelled outside the case body 11.

In the present embodiment, the sealing plate 13 is provided with a pair of electrode terminals 17 and 18. The pair of electrode terminals 17 and 18 are disposed at the opposite ends of the width axis Y of the sealing plate 13. Note that the method of attaching the electrode terminals 17 and 18 to the sealing plate 13 is not limited to any particular method. For example, the electrode terminals 17 and 18 may be attached to the sealing plate 13 by, for example, using a crimping process. The electrode terminals 17 and 18 may be integrally formed with the sealing plate 13. Herein, as illustrated in FIG. 2, the electrode terminal 17 includes an external terminal 17a and an internal terminal 17b. The external terminal 17a is attached to the upper side of the sealing plate 13. The internal terminal 17b is attached to the lower side of the sealing plate 13. The electrode terminal 18, like the electrode terminal 17, includes an external terminal 18a that is attached to the upper side of the sealing plate 13 and an internal terminal 18b that is attached to the lower end of the sealing plate 13.

As illustrated in FIG. 2, the electrode body 20 is housed inside the case body 11. The electrode body 20 has a flat shape. Although not shown in the drawings, the electrode body 20 includes a positive electrode and a negative electrode. The electrode body 20 is, for example, a wound electrode assembly in which a strip-shaped positive electrode and a strip-shaped negative electrode are stacked with a strip-shaped separator interposed therebetween and they are wound in a longitudinal direction around the winding axis. However, the configuration of the electrode body 20 is not limited to any particular configuration. For the electrode body 20, it is possible to use various types of conventionally known electrode bodies. For example, the electrode body 20 may be a stacked electrode body in which a rectangular-shaped positive electrode sheet and a rectangular-shaped negative electrode sheet are stacked with the positive electrode sheet and the negative electrode sheet being electrically insulated from each other. Herein, the electrode body 20 is housed in the case body 11 in such an orientation that the winding axis is substantially parallel to the width axis Y. It is also possible that the electrode body 20 may be housed in the case body 11 in such an orientation that the winding axis is substantially parallel to the height axis Z. The number of electrode bodies 20 to be housed in the case body 11 may be one, or two or more.

In the present embodiment, the positive electrode of the electrode body 20 is connected to the internal terminal 17b of the electrode terminal 17 shown in FIG. 2. Accordingly, the electrode terminal 17 is a positive electrode terminal that is electrically connected to the positive electrode of the electrode body 20. The negative electrode of the electrode body 20 is connected to the internal terminal 18b of the electrode terminal 18. Accordingly, the electrode terminal 18 is a negative electrode terminal that is electrically connected to the negative electrode of the electrode body 20.

Although not shown in the drawings, the positive electrode of the electrode body 20 includes a positive electrode current collector and a positive electrode mixture layer firmly adhered to the positive electrode current collector. The positive electrode current collector is made of, for example, an electrically conductive metal, such as aluminum, aluminum alloys, nickel, and stainless steel. The positive electrode current collector herein is made of aluminum. The positive electrode mixture layer typically contains a positive electrode active material that is capable of reversibly absorbing and releasing a charge carrier (for example, a lithium-transition metal composite oxide) and a binder (for example, polyvinylidene difluoride (PVdF)).

Although not shown in the drawings, the negative electrode of the electrode body 20 includes a negative electrode current collector and a negative electrode mixture layer firmly adhered to the negative electrode current collector. The negative electrode current collector is made of, for example, an electrically conductive metal, such as copper, copper alloys, nickel, and stainless steel. The negative electrode current collector herein is made of copper. The negative electrode mixture layer typically contains a negative electrode active material that is capable of reversibly absorbing and releasing a charge carrier (for example, a carbon material, such as graphite) and a binder (for example, styrene-butadiene rubber (SBR) or carboxymethylcellulose (CMC)).

In the present embodiment, the electrode body 20 is impregnated with an electrolyte solution (not shown). Herein, the electrolyte solution is a non-aqueous liquid electrolyte (non-aqueous electrolyte solution) containing a non-aqueous solvent and a supporting salt. The non-aqueous solvent may contain, for example, a carbonate, such as ethylene carbonate (EC), dimethyl carbonate (DMC), and ethyl methyl carbonate (EMC). The supporting salt is, for example, a fluorine-containing lithium salt, such as LiPF₆. Herein, the electrolyte solution may be in a solid state (i.e., what is called a solid electrolyte) or may be integrated with the electrode body 20. In addition, an excessive electrolyte solution that cannot be impregnated in the electrode body 20 may be stored inside the case body 11.

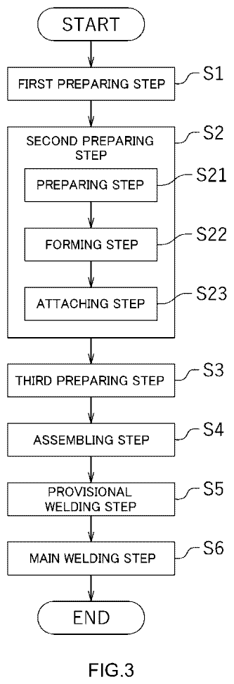

Hereinabove, an exemplary configuration of the electricity storage device 10 according to the present embodiment has been described. Next, an embodiment of a method of manufacturing the electricity storage device 10 will be described below. FIG. 3 is a flowchart illustrating one example of the method of manufacturing an electricity storage device 10. As illustrated in FIG. 3, the method of manufacturing an electricity storage device 10 includes a first preparing step S1, a second preparing step S2, a third preparing step S3, an assembling step S4, a provisional welding step S5, and a main welding step S6. The method of manufacturing an electricity storage device 10 may additionally include other steps mentioned above, but the description thereof is omitted herein. In the method of manufacturing an electricity storage device 10 shown in FIG. 3, the case body 11 (see FIG. 2) and the circumferential end portion 13a of the sealing plate 13 (see FIG. 2) are welded together by laser welding. Hereinafter, laser welding may be referred to simply as welding.

The first preparing step S1 of FIG. 3 is a step of preparing a prismatic case body 11 (see FIG. 2) having an open end 11d. In the first preparing step S1, the method of preparing the case body 11 is not limited to any particular method. The case body 11 is prepared by, for example, bending and shaping a rectangular-shaped metal flat plate (i.e., a flat plate formed of aluminum or an aluminum alloy).

Next, the second preparing step S2 of FIG. 3 is performed. The second preparing step S2 is a step of preparing a sealing plate 13 (see FIG. 2) for sealing the open end 11d of the case body 11. The second preparing step S2 prepares a sealing plate 13 provided with electrode terminals 17 and 18. In the present embodiment, the second preparing step S2 includes a preparing step S21, a forming step S22, and an attaching step S23. By executing the preparing step S21, the forming step S22, and the attaching step S23 successively, it is possible to prepare the sealing plate 13 in the second preparing step S2.

The preparing step S21 of FIG. 3 prepares a sealing plate 13 formed into a predetermined shape (for example, a rectangular shape herein). In the present embodiment, the sealing plate 13 is prepared by, for example, processing a single sheet of rectangular-shaped flat plate. Herein, in order to prepare a sealing plate 13 formed into a predetermined shape from the just-mentioned single sheet of flat plate, a blanking process is performed. Although not shown in the drawings, in the blanking process, the just-mentioned flat plate is sandwiched between a blanking die and a blanking plate and pressure is applied to the flat plate, so that the sealing plate 13 in a predetermined shape is produced.

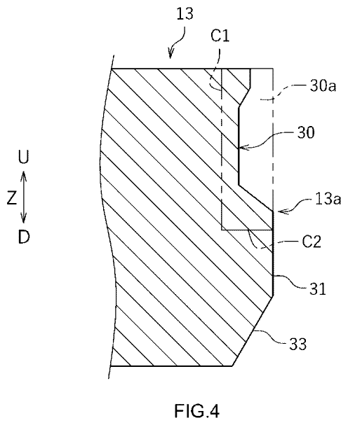

FIG. 4 is a cross-sectional view illustrating a fracture surface 30 of the sealing plate 13 prepared in the preparing step S21. The cross-sectional view shown in FIG. 4 is a vertical cross-sectional view of the circumferential end portion 13a of the sealing plate 13 taken along the height axis Z. In the present embodiment, it is possible that the fracture surface 30 may be formed in the sealing plate 13, as shown in FIG. 4, by the above-described blanking process. The fracture surface 30 is formed, for example, in the circumferential end portion 13a of the sealing plate 13, in other words, in a side surface of the sealing plate 13. The fracture surface 30 is formed along the circumference of the of the sealing plate 13. The fracture surface 30 may be formed in an upper portion of the side surface of the sealing plate 13 by a blanking process in which pressure is applied to the above-mentioned single sheet of rectangular-shaped flat plate in a vertical direction. Herein, the direction toward the center of the sealing plate 13 in plan view is referred to as “inward”, and the opposite direction to “inward” is referred to as “outward”. In the present embodiment, the fracture surface 30 refers to a face of the sealing plate 13 that is formed by the blanking process and is recessed inward, of the side surface of the sealing plate 13. Although the fracture surface 30 is formed along the circumference of the of the sealing plate 13, the shape of the fracture surface 30 may not be uniform but may vary depending on the circumferential location in the sealing plate 13. The phrase “shape of the fracture surface 30” may include the way in which it recesses inward, the degree of the recess inward of the sealing plate 13, the length thereof along the height axis Z, and the like.

In the present embodiment, as shown in FIG. 4, in the sealing plate 13 after the blanking process, a face of the side surface of the sealing plate 13 that is not recessed inward, unlike the fracture surface 30, is referred to as a shear surface 31. The shear surface 31 is disposed, for example, downward relative to the fracture surface 30.

In the present embodiment, as illustrated in FIG. 4, the sealing plate 13 prepared in the preparing step S21 is provided with a chamfer 33. Herein, the chamfer 33 is formed in the circumferential end portion 13a of the lower surface of the sealing plate 13. The chamfer 33 is formed in the sealing plate 13 so that the lower corner of the sealing plate 13 is chamfered. The chamfer 33 is formed along the circumference of the sealing plate 13 and around the entire circumference of the sealing plate 13. In the present embodiment, the chamfer 33 is disposed downward relative to the fracture surface 30 and also downward relative to the shear surface 31. The chamfer 33 is formed by subjecting the sealing plate 13 to a machining process, such as a cutting process, in the preparing step S21. However, the chamfer 33 may be formed in advance in the sealing plate 13. Note that the chamfer 33 is not depicted in FIG. 2.

When laser welding the case body 11 (more specifically the edge of the open end 11d) and the circumferential end portion 13a of the sealing plate 13 from above, it is desirable to provide a stable weld depth. This weld depth means the depth of the weld from the upper surface of the sealing plate 13 when laser welding the case body 11 and the sealing plate 13 together. In other words, by performing laser welding, a weld mark is formed between the case body 11 and the sealing plate 13. The weld depth means the length of the weld mark along the height axis Z (hereinafter also referred to as the length of the weld mark). The weld mark is formed along the circumferential end portion 13a of the sealing plate 13 around the entire circumference of the sealing plate 13. The phrase “stable weld depth” means the state in which the depth of the welding along the circumferential end portion 13a of the sealing plate 13 is within a predetermined range. For example, when the length of the weld mark along the circumferential end portion 13a of the sealing plate 13 is within a predetermined range, a stable weld depth may be provided. It is preferable that the predetermined range be narrower. By thus providing a stable weld depth in laser welding, the strength of welding may be sufficiently provided uniformly around the entire circumference.

In the past, however, it has been difficult to ensure a stable weld depth when laser welding the case body 11 and the circumferential end portion 13a of the sealing plate 13. In view of the problem, the present inventor conducted various studies on the cause of the difficulty in providing a stable weld depth when manufacturing the electricity storage device 10. As a result, it was discovered that a stable weld depth can be ensured by processing the circumferential end portion 13a of the upper surface of the sealing plate 13 in such a manner that a gap is formed between the sealing plate 13 and the edge of the open end 11d of the case body 11 when the sealing plate 13 is attached to the open end 11d of the case body 11 before the laser welding.

Moreover, the present inventor found that it is difficult to ensure a stable weld depth if the sealing plate 13 is laser welded in such a state that the fracture surface 30 as shown in FIG. 4 is formed. As described above, the shape of the fracture surface 30 may vary depending on the circumferential position in the sealing plate 13. For this reason, in laser welding, variations in the weld depth may result because of variations in the shape of the fracture surface 30, depending on the circumferential position in the sealing plate 13. As a consequence, it is believed to be difficult to ensure a stable weld depth.

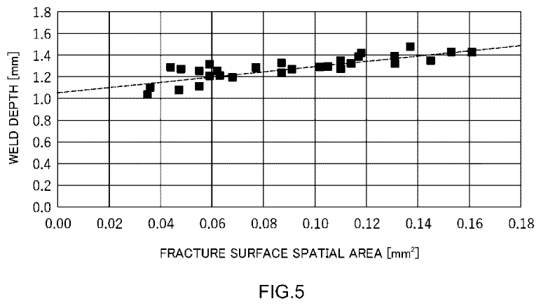

FIG. 5 is a graph showing the correlation between the weld depth and the fracture surface spatial area in the fracture surface 30. The present inventor has investigated the correlation between the weld depth and the fracture surface spatial area of the fracture surface 30 that is formed in the sealing plate 13. The term “fracture surface spatial area of the fracture surface 30” herein means, as illustrated in FIG. 4, a fracture surface spatial area 30a formed by the fracture surface 30 that is recessed by the blanking process. As illustrated in FIG. 5, when the fracture surface spatial area of the fracture surface 30 is approximately within the range of 0.04 mm² to 0.16 mm², the weld depth may result in the range of 1.0 mm to 1.5 mm. It is preferable that the range of the weld depth be narrower, and when the weld depth is within the range of about 1.2 mm to about 1.4 mm, it can be said that the weld depth is stable. Herein, when the shape of the fracture surface 30 varies depending the circumferential position in the sealing plate 13, the fracture surface spatial area of the fracture surface 30 results in a wider range. Thus, when the shape of the fracture surface 30 varies depending the circumferential position in the sealing plate 13, the possible range of the weld depth becomes wider, making it difficult to ensure a stable weld depth.

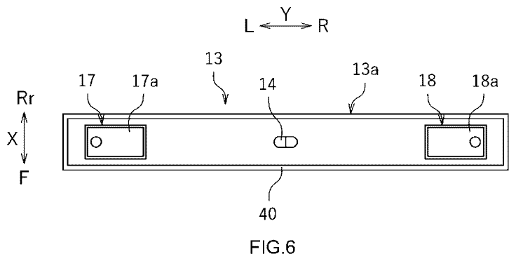

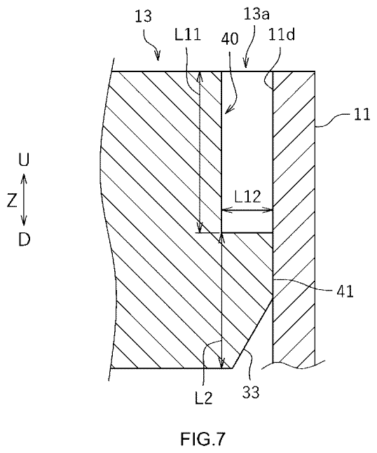

FIG. 6 is a plan view illustrating the sealing plate 13 prepared in the second preparing step S2. FIG. 7 is a cross-sectional view illustrating the sealing plate 13 prepared in the second preparing step S2. FIG. 7 is a cross-sectional view illustrating the circumferential end portion 13a of the sealing plate 13 taken along the height axis Z, which is a view corresponding to FIG. 4. FIG. 7 shows a state in which the sealing plate 13 is attached to the open end 11d of the case body 11. In order to solve the above-described problem, in the present embodiment, the second preparing step S2 prepares a sealing plate 13 in which a recessed portion 40 is formed in the circumferential end portion 13a of the upper surface of the sealing plate 13, as illustrated in FIG. 7. The sealing plate 13 prepared in the second preparing step S2 includes a recessed portion 40 recessed downwardly in the circumferential end portion 13a of the upper surface of the sealing plate 13. By forming such a recessed portion 40 in the sealing plate 13, it is possible to form a gap between the sealing plate 13 and the case body 11 when the sealing plate 13 is attached to the open end 11d of the case body 11. In addition, by forming the recessed portion 40 in the circumferential end portion 13a of the sealing plate 13, it is possible to remove the fracture surface 30 (see FIG. 4). Then, in laser welding, a laser beam is applied to the recessed portion 40, so that a stable weld depth can be ensured. Note that the recessed portion 40 is not depicted in FIGS. 1 and 2.

In the present embodiment, the recessed portion 40 is formed in the circumferential end portion 13a of the sealing plate 13 in the forming step S22 of FIG. 3. The forming step S22 is a step that is performed after the preparing step S21. The forming step S22 forms the recessed portion 40 in the sealing plate 13 prepared in the preparing step S21. The forming step S22 forms the recessed portion 40 so that it recesses downwardly from the circumferential end portion 13a of the upper surface of the sealing plate 13. At this time, the recessed portion 40 is formed along the circumference of the sealing plate 13 around the entire circumference of the sealing plate 13, as illustrated in FIG. 6. In the present embodiment, for the sealing plate 13 in which the fracture surface 30 is formed in the preparing step S21, the recessed portion 40 is formed in the sealing plate 13 so as to cut the fracture surface 30. For example, as illustrated in FIG. 4, the circumferential end portion 13a of the sealing plate 13 is cut off to the position indicated by the dash-dot-dot line designated by reference characters C1 and C2, to thereby form the recessed portion 40. Herein, it is preferable that the sealing plate 13 in which the recessed portion 40 is formed in the forming step S22 not have the fracture surface 30 formed in the preparing step S21. It is possible, however, that, in the sealing plate 13 in which the recessed portion 40 is formed in the forming step S22, some portion of the fracture surface 30 may remain or another portion of the fracture surface 30 may be cut off. It should be noted that in the forming step S22, the method of forming the recessed portion 40 in the sealing plate 13 is not limited to any particular method. Herein, the recessed portion 40 is formed along the circumference of the sealing plate 13 by cutting the fracture surface 30 and the circumferential end portion 13a of the upper surface of the sealing plate 13 using a cutting process (for example, a milling process).

As illustrated in FIG. 7, the sealing plate 13 prepared in the second preparing step S2 includes a thick wall portion 41 disposed below the recessed portion 40. For this reason, the recessed portion 40 is formed so as not to penetrate the sealing plate 13 in a direction of the height axis Z. Herein, the thick wall portion 41 and the chamfer 33 are provided below the recessed portion 40. The thick wall portion 41 forms the chamfer 33. The chamfer 33 is formed in the circumferential end portion 13a of the lower surface of the thick wall portion 41.

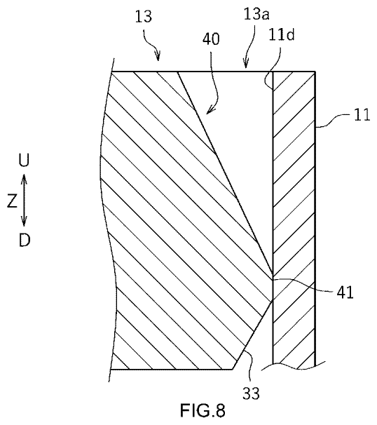

In the present embodiment, the recessed portion 40 is rectangular in cross-sectional shape. However, the cross-sectional shape of the recessed portion 40 is not limited to any particular shape. For example, as shown in the modified example of FIG. 8, the cross-sectional shape of the recessed portion 40 may be triangular. The term “cross-sectional shape of the recessed portion 40” refers to the shape of the recessed portion 40 when it is cut radially along the height axis Z so as to pass through the center of the sealing plate 13.

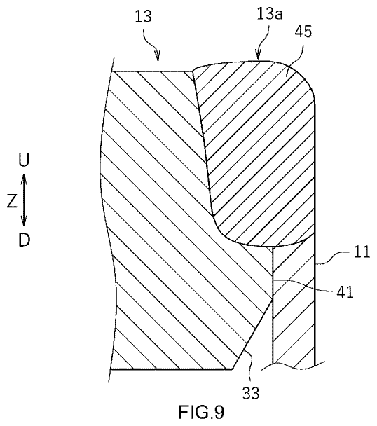

In the present embodiment, as illustrated in FIG. 7, the recessed portion 40 has a depth L11 that is greater than a width L12 of the recessed portion 40. Herein, the depth L11 of the recessed portion 40 is less than or equal to the average weld depth of the welded portion in the main welding step S6. FIG. 9 is a cross-sectional view illustrating a state in which the case body 11 and the sealing plate 13 are welded. FIG. 9 is a cross-sectional view illustrating the circumferential end portion 13a of the sealing plate 13 taken along the height axis Z, which is a view corresponding to FIG. 4. As illustrated in FIG. 9, a weld mark 45 is formed between the case body 11 and the sealing plate 13 when welding the case body 11 and the sealing plate 13 together. It is preferable that no gap is formed between the weld mark 45 and the thick wall portion 41 after welding. In other words, it is preferable that the recessed portion 40 be in a condition that it is filled with the weld mark 45. Thus, in order to make a gap difficult to form between the weld mark 45 and the thick wall portion 41, the depth L11 of the recessed portion 40 may be set to be less than or equal to the average weld depth of the portion that is welded in the main welding step S6. In addition, in the present embodiment, the height L2 of the thick wall portion 41 is less than the depth L11 of the recessed portion 40, as illustrated in FIG. 7. However, the height L2 of the thick wall portion 41 may the same as the depth L11 of the recessed portion 40, or may be greater than the depth L11 of the recessed portion 40. The height L2 of the thick wall portion 41 is determined according to the thickness of the sealing plate 13 and the depth L11 of the recessed portion 40.

For example, the depth L11 of the recessed portion 40 is greater than or equal to 1.0 mm and less than or equal to 2.0 mm, preferably greater than or equal to 1.0 mm and less than or equal to 1.5 mm. If the depth L11 of the recessed portion 40 is set to be greater than 2.0 mm, a gap may be likely to form between the weld mark 45 and the thick wall portion 41 after welding. The depth L11 of the recessed portion 40 may be determined within a range in which the advantageous effect is obtained. In addition, for example, the width L12 of the recessed portion 40 is less than or equal to 0.2 mm, preferably greater than or equal to 0.1 mm and less than or equal to 0.2 mm. The width L12 of the recessed portion 40 may be determined within a range in which the advantageous effect is obtained.

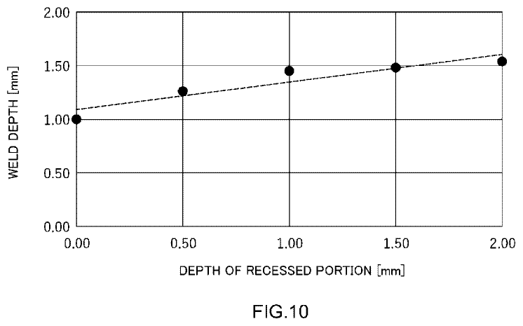

The present inventor has investigated the correlation between the depth L11 of the recessed portion 40 and the weld depth as well as the correlation between the width L12 of the recessed portion 40 and the weld depth. Herein, a sealing plate 13 made of aluminum was prepared that has a dimension along the thickness axis X of 38 mm, a dimension along the width axis Y of 306 mm, and a dimension along the height axis Z of 2.5 mm. The dimension of the chamfer 33 along the height axis Z of this sealing plate 13 is 0.4 mm. The sealing plate 13 having such dimensions was subjected to a cutting process to form the recessed portion 40. At this time, the weld depth after laser welding was calculated for recessed portions 40 having a depth L11 of 0.0 mm, 0.5 mm, 1.0 mm, 1.5 mm, and 2.0 mm, respectively, with the width L12 of the recessed portion 40 being fixed (for example, at 0.2 mm). The correlation between the depth L11 of the recessed portion 40 and the weld depth is shown in FIG. 10.

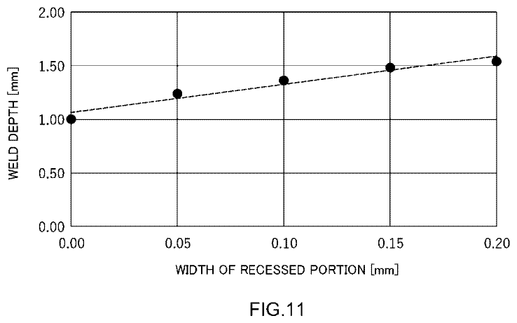

Next, as described above, for a sealing plate 13 made of aluminum that has a dimension along the thickness axis X of 38 mm, a dimension along the width axis Y of 306 mm, and a dimension along the height axis Z of 2.5 mm, the weld depth after laser welding was calculated when forming recessed portions 40 that have a width L12 of 0.00 mm, 0.05 mm, 0.10 mm, 0.15 mm, and 0.20 mm, with the depth L11 being made constant (for example, 2.0 mm). The correlation between the width L12 of the recessed portion 40 and the weld depth is shown in FIG. 11.

As shown in FIG. 10, in the relation between the depth L11 of the recessed portion 40 and the weld depth (the expression representing the approximated line indicated by the dashed line of FIG. 10), the slope was 0.3 and the correlation coefficient was 0.93. On the other hand, as shown in FIG. 11, in the relation between the depth width L12 of the recessed portion 40 and the weld depth (the expression representing the approximated line indicated by the dashed line of FIG. 11), the slope was 2.6 and the correlation coefficient was 0.97. This indicates that increasing the width L12 of the recessed portion 40 causes the weld depth to increase more easily than increasing the depth L11 of the recessed portion 40. In other words, it is indicated that, as for the depth L11 and the width L12 of the recessed portion 40, the width L12 has a greater influence on the weld depth than the depth L11 when the amount of change is the same. For that reason, the present embodiment makes the depth L11 of the recessed portion 40 greater than the width L12 of the recessed portion 40. It should be noted that making the recessed portion 40 greater tends to cause multiple reflection easily when applying a laser beam to the recessed portion 40. This is believed to increase the amount of energy of the laser beam absorbed in the welded portion, and as a result, the weld depth increases accordingly.

After forming the recessed portion 40 in the sealing plate 13 in the forming step S22 of FIG. 3 as described above, the attaching step S23 of FIG. 3 is performed. The attaching step S23 attaches the electrode terminals 17 and 18 to the sealing plate 13, as illustrated in FIG. 2. Note that the method of attaching the electrode terminals 17 and 18 to the sealing plate 13 is not limited to any particular method. Herein, by performing a hole-forming process in the sealing plate 13, an insertion hole is formed in each of the opposite ends of the width axis Y of the sealing plate 13. Then, after inserting the electrode terminals 17 and 18 into the respective insertion holes, the electrode terminals 17 and 18 can be attached to the sealing plate 13 by using a crimping process.

In the present embodiment, the attaching step S23 is performed after the forming step S22, as illustrated in FIG. 3. However, the attaching step S23 may be performed before the forming step S22 or may be performed simultaneously with, for example, the preparing step S21. In other words, attaching the electrode terminals 17 and 18 to the sealing plate 13 may be carried out after forming the recessed portion 40 in the sealing plate 13 or before forming the recessed portion 40 in the sealing plate 13.

After the sealing plate 13 in which the recessed portion 40 is formed (see FIG. 7) is prepared in the second preparing step S2 of FIG. 3 as described above, the third preparing step S3 of FIG. 3 is performed. The third preparing step S3 is a step of preparing a flat electrode body 20 (see FIG. 2), which is to be housed in the case body 11. In the third preparing step S3, the method of preparing the electrode body 20 is not limited to any particular method. As described above, the electrode body 20 is produced by, for example, laminating and winding a positive electrode, a negative electrode, and a separator. The third preparing step S3 prepares the electrode body 20 produced in such a manner.

The order of performing the first preparing step S1, the second preparing step S2, and the third preparing step S3 is not limited to any particular order. Any of the first preparing step S1, the second preparing step S2, and the third preparing step S3 may be performed first or last.

After performing the first preparing step S1 to the third preparing step S3 as described above, the assembling step S4 of FIG. 3 is performed. The assembling step S4 assembles the electricity storage device 10. Herein, the electrode body 20 is fitted to the sealing plate 13, as illustrated in FIG. 2. More specifically, the electrode body 20 is fitted to the electrode terminals 17 and 18 provided on the sealing plate 13. For example, the positive electrode of the electrode body 20 is electrically connected to the internal terminal 17b of the electrode terminal 17 on the sealing plate 13 by laser welding. The negative electrode of the electrode body 20 is electrically connected to the internal terminal 18b of the electrode terminal 18 on the sealing plate 13 by laser welding. Thereafter, the electrode body 20 connected to the sealing plate 13 is accommodated into the case body 11, and the sealing plate 13 is attached to the open end 11d of the case body 11. At this time, the sealing plate 13 is sandwiched between the pair of narrower surfaces 11b and also sandwiched between the pair of wider surfaces 11c. It is also possible that in the assembling step S4, the electrode body 20 may be connected to the electrode terminals 17 and 18 of the sealing plate 13 after accommodating the electrode body 20 into the case body 11, and the sealing plate 13 may be attached to the open end 11d of the case body 11.

Next, the provisional welding step S5 of FIG. 3 is performed. The provisional welding step S5 provisionally welds the case body 11 and the sealing plate 13 with the sealing plate 13 being attached to the open end 11d of the case body 11. In the provisional welding step S5, provisional welding is conducted in order to determine the position of the sealing plate 13 relative to the case body 11. Herein, a laser beam is applied from above the sealing plate 13 to a predetermined portion of the boundary portion between the case body 11 and the sealing plate 13 (the recessed portion 40 formed along the circumference of the sealing plate 13 herein), to provisionally weld the case body 11 and the sealing plate 13. For example, in the provisional welding step S5, the case body 11 and the sealing plate 13 are welded intermittently. Herein, provisional welding is performed for a plurality of predetermined locations of the boundary portion between the case body 11 and the sealing plate 13 (the recessed portion 40 of the sealing plate 13 herein). In the provisional welding step S5, various types of conventionally known welding devices may be used to provisionally weld the case body 11 and the sealing plate 13. The provisional welding is performed under the conditions of a laser beam diameter of 0.6 mm, a laser beam output power of 3000 W, and a laser beam move speed of 150 mm/s. However, the conditions of the provisional welding are not particularly limited. In addition, the provisional welding step S5 may be omitted.

After performing the provisional welding step S5 in this way, the main welding step S6 of FIG. 3 is performed. The main welding step S6 is an example of the welding step. In the main welding step S6, a laser beam is applied along the boundary between the case body 11 and the sealing plate 13 to perform welding. Herein, a laser beam is applied along the boundary portion between the case body 11 and the circumferential end portion 13a of the sealing plate 13 to weld the case body 11 and the sealing plate 13 around the entire circumference. In the present embodiment, the recessed portion 40 is formed in the circumferential end portion 13a of the upper surface of the sealing plate 13. Therefore, in the main welding step S6, a laser beam is applied to the recessed portion 40 of the sealing plate 13 to perform welding. At this time, the laser beam causes the region around the recessed portion 40 to melt, so that the weld mark 45 (see FIG. 9) is formed in the portion where the recessed portion 40 has been formed. In the main welding step S6, various types of conventionally known welding devices may be used to fully weld the case body 11 and the sealing plate 13. The welding device used in the main welding step S6 may be the same as or different from the welding device used in the provisional welding step S5. The main welding in the main welding step S6 is performed under the conditions of a laser beam diameter of 0.8 mm to 1.0 mm, a laser beam output power of 6000 W, and a laser beam move speed of 300 mm/s. However, the conditions of the main welding are not particularly limited.

Upon completion of the main welding step S6, the case body 11 and the sealing plate 13 are brought into a state in which they are welded together around the entire circumference of the circumferential end portion 13a of the sealing plate 13. This causes the inside of the case body 11 to be hermetically sealed. Although not shown in the drawings, various steps are performed as appropriate after the main welding step S6 to produce the electricity storage device 10, the various steps including a filling step of filling an electrolyte solution into the case body 11, an aging step of charging the electricity storage device 10 and thereafter allowing it to stand for a predetermined time, and an inspecting step of inspecting the electricity storage device 10 for internal short circuits or the like.

As has been described above, the method of manufacturing an electricity storage device 10 according to the present embodiment includes, as illustrated in FIG. 3, the first preparing step S1, the second preparing step S2, and the assembling step S4, and the main welding step S6. The first preparing step S1 prepares the case body 11 (see FIG. 2) having the open end 11d. The second preparing step S2 prepares the sealing plate 13 (see FIG. 6) for sealing the open end 11d of the case body 11. The assembling step S4 attaches the sealing plate 13 to the open end 11d of the case body 11. In the main welding step S6, a laser beam is applied along the boundary between the case body 11 and the sealing plate 13 to perform welding. Here, the sealing plate 13 prepared in the second preparing step S2 includes the recessed portion 40 recessed downwardly in the circumferential end portion 13a of the upper surface of the sealing plate 13, as illustrated in FIG. 7. In the main welding step S6, a laser beam is applied to the recessed portion 40 of the sealing plate 13 to perform welding. Thus, the recessed portion 40 is formed in the circumferential end portion 13a of the upper surface of the sealing plate 13 and a laser beam is applied toward the recessed portion 40, whereby the weld mark 45 (see FIG. 9) is formed on the recessed portion 40. The weld mark 45 formed on the recessed portion 40 is likely to have a uniform length along the height axis Z. As a result, it is possible to ensure a stable weld depth.

In the present embodiment, the second preparing step S2 includes the preparing step S21 and the forming step S22, as shown in FIG. 3. In the preparing step S21, a sealing plate 13 formed into a predetermined shape (herein, a sealing plate 13 in which the recessed portion 40 is not formed) is prepared. In the forming step S22, the recessed portion 40 (see FIG. 7) is formed in the sealing plate 13 prepared in the preparing step S21. This allows the operator to appropriately set the dimensions of the depth L11 and the width L12 of the recessed portion 40 according to the size of the sealing plate 13 (i.e., the dimensions thereof along the thickness axis X, the width axis Y, and the height axis Z). This makes it easier to ensure a stable weld depth even when the size of the sealing plate 13 varies.

In the present embodiment, the preparing step S21 of FIG. 3 performs a blanking process to thereby prepare the sealing plate 13 including the fracture surface 30 (see FIG. 4) formed in a side surface thereof. The forming step S22 of FIG. 3 forms the recessed portion 40 in the sealing plate 13 so as to shave off the fracture surface 30. As described previously, variations in weld depth are likely to occur when the case body 11 and the sealing plate 13 are welded in a state in which the shape of the fracture surface 30 varies depending on the circumferential position of the sealing plate 13. In view of this, the present embodiment forms the recessed portion 40 in the sealing plate 13 so as to shave off the fracture surface 30, making it possible to weld the sealing plate 13 from which the fracture surface 30 has been removed to the case body 11. As a result, the welding is done without adversely being affected by variations in the shape of the fracture surface 30, so that a stable weld depth can be ensured.

In the present embodiment, the sealing plate 13 prepared in the second preparing step S2 includes the thick wall portion 41 disposed below the recessed portion 40, as illustrated in FIG. 7. This reduces the risk of laser penetration, which is caused by a laser beam penetrating through the sealing plate 13 when a laser beam is applied to the recessed portion 40 in the main welding step S6.

As described previously, as for the depth L11 and the width L12 of the recessed portion 40, the width L12 has a greater influence on the weld depth than the depth L11 when the amount of change is the same, as shown in FIGS. 10 and 11. Accordingly, the present embodiment makes the depth L11 of the recessed portion 40 greater than the width L12 of the recessed portion 40, so that variations in the weld depth is easily reduced. As a result, it is possible to ensure a stable weld depth easily.

In the present embodiment, the cross-sectional shape of the recessed portion 40 is rectangular, as illustrated in FIG. 7. The width L12 of the recessed portion 40 is less than or equal to 0.2 mm. The depth L11 of the recessed portion 40 is less than or equal to 2.0 mm. Restricting the shape and size of the recessed portion 40 in this way makes it possible to reduce the risk of laser penetration and to ensure a stable weld depth.

In the present embodiment, the depth L11 of the recessed portion 40 is less than or equal to the average weld depth of the welded portion in the main welding step S6. This makes it difficult to form a gap space inside the recessed portion 40 when applying a laser beam to the recessed portion 40 to perform welding. In other words, it is unlikely to form a gap space between the weld mark 45 and the thick wall portion 41 after welding, as illustrated in FIG. 9.

In the present embodiment, the recessed portion 40 is formed in the sealing plate 13 in the forming step S22 of the second preparing step S2. However, it is also possible that the recessed portion 40 may be formed, for example, without performing the operation of forming it in the sealing plate 13, and the recessed portion 40 may have already been formed when the sealing plate 13 is prepared in the preparing step S21. In other words, in the preparing step S21, it is possible to prepare a sealing plate 13 in which the recessed portion 40 has been formed in advance. In this case, the forming step S22 may be omitted.

As has been described above, the present description contains the disclosure as set forth in the following items.

Item 1:
A method of manufacturing an electricity storage device, including:
   a first preparing step of preparing a case body including an open end;
   a second preparing step of preparing a sealing plate sealing the open end of the case body;
   an assembling step of attaching the sealing plate to the open end of the case body; and
   a welding step of welding the case body and the sealing plate by applying a laser beam along a boundary between the case body and the sealing plate, wherein:
      the sealing plate prepared in the second preparing step includes a recessed portion recessed downwardly in a circumferential end portion of an upper surface of the sealing plate; and
      in the welding step, the laser beam is applied to the recessed portion of the sealing plate to weld the case body and the sealing plate.

Item 2:
The method of manufacturing an electricity storage device according to item 1, wherein:
   the second preparing step includes:
      a preparing step of preparing the sealing plate formed into a predetermined shape; and
      a forming step of forming the recessed portion in the sealing plate prepared in the preparing step.

Item 3:
The method of manufacturing an electricity storage device according to item 2, wherein:
   the preparing step includes performing a blanking process to prepare the sealing plate including a fracture surface formed in a side surface of the sealing plate; and
   the forming step includes forming the recessed portion so as to shave off the fracture surface.

Item 4:
The method of manufacturing an electricity storage device according to any one of items 1 through 3, wherein the recessed portion is rectangular in cross-sectional shape.

Item 5:
The method of manufacturing an electricity storage device according to any one of items 1 through 4, wherein the sealing plate prepared in the second preparing step includes a thick wall portion disposed below the recessed portion.

Item 6:
The method of manufacturing an electricity storage device according to any one of items 1 through 5, wherein the recessed portion is greater in depth than width.

Item 7:
The method of manufacturing an electricity storage device according to any one of items 1 through 6, wherein the recessed portion has a width of less than or equal to 0.2 mm.

Item 8:
The method of manufacturing an electricity storage device according to any one of items 1 through 7, wherein the recessed portion has a depth of less than or equal to 2.0 mm.

Item 9:
The method of manufacturing an electricity storage device according to any one of items 1 through 8, wherein the recessed portion has a depth that is less than or equal to an average weld depth of a portion that is welded in the welding step.

What is claimed is:

1. A method of manufacturing an electricity storage device, comprising:
a first preparing step of preparing a case body including an open end;
a second preparing step of preparing a sealing plate sealing the open end of the case body;
an assembling step of attaching the sealing plate to the open end of the case body; and
a welding step of welding the case body and the sealing plate by applying a laser beam along a boundary between the case body and the sealing plate, wherein:
the sealing plate prepared in the second preparing step includes a recessed portion recessed downwardly in a circumferential end portion of an upper surface of the sealing plate; and
in the welding step, the laser beam is applied to the recessed portion of the sealing plate to weld the case body and the sealing plate.

2. The method of manufacturing an electricity storage device according to claim 1, wherein:
the second preparing step includes:
a preparing step of preparing the sealing plate formed into a predetermined shape; and
a forming step of forming the recessed portion in the sealing plate prepared in the preparing step.

3. The method of manufacturing an electricity storage device according to claim 2, wherein:
the preparing step includes performing a blanking process to prepare the sealing plate including a fracture surface formed in a side surface of the sealing plate; and
the forming step includes forming the recessed portion so as to shave off the fracture surface.

4. The method of manufacturing an electricity storage device according to claim 1, wherein the recessed portion is rectangular in cross-sectional shape.

5. The method of manufacturing an electricity storage device according to claim 1, wherein the sealing plate prepared in the second preparing step includes a thick wall portion disposed below the recessed portion.

6. The method of manufacturing an electricity storage device according to claim 1, wherein the recessed portion is greater in depth than width.

7. The method of manufacturing an electricity storage device according to claim 1, wherein the recessed portion has a width of less than or equal to 0.2 mm.

8. The method of manufacturing an electricity storage device according to claim 1, wherein the recessed portion has a depth of less than or equal to 2.0 mm.

9. The method of manufacturing an electricity storage device according to claim 1, wherein the recessed portion has a depth that is less than or equal to an average weld depth of a portion that is welded in the welding step.
